(19) United States
(12) Patent Application Publication
(10) Pub. No.: US 2024/0259854 A1
(43) Pub. Date: Aug. 1, 2024

(54) METHOD AND APPARATUS FOR REPLACING LOCATION OF USER EQUIPMENT WITH LOCATION OF SERVING CELL IN WIRELESS COMMUNICATION SYSTEM

(71) Applicant: SAMSUNG ELECTRONICS CO., LTD., Suwon-si (KR)

(72) Inventors: June HWANG, Suwon-si (KR); Hyunjeong KANG, Suwon-si (KR); Taeseop LEE, Suwon-si (KR)

(21) Appl. No.: 18/421,705

(22) Filed: Jan. 24, 2024

(30) Foreign Application Priority Data
Jan. 26, 2023 (KR) 10-2023-0009929

(51) Int. Cl. H04W 28/02; H04W 64/00

(52) U.S. Cl. CPC H04W 28/0226; H04W 28/021; H04W 64/003

(57) ABSTRACT

The disclosure relates to a 5G or 6G communication system for supporting a higher data transfer rate. A method performed by an access and mobility management function (AMF) entity in a wireless communication system is provided. The method comprises: receiving a first message for requesting information on a location of a target user equipment (UE); transmitting, to a location management function (LMF) entity, a second message for requesting the information on the location of the target UE; and receiving, from the LMF entity, a third message including the information on the location of the target UE, wherein the second message includes identification information about a serving cell for the target UE, and information about whether the serving cell is a moving cell.

### CROSS-REFERENCE TO RELATED APPLICATION

This application is based on and claims priority under 35 U.S.C. § 119 to Korean Patent Application No. 10-2023-0009929, filed on Jan. 26, 2023, in the Korean Intellectual Property Office, the disclosure of which is herein incorporated by reference in its entirety.

### BACKGROUND

### 1. Field

The disclosure relates to an operation of a user equipment (UE) in a wireless communication system. Specifically, the disclosure relates to a technique for deducing the location of a specific UE by using communication between UEs.

### 2. Description of Related Art

5^{th} generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement 6^{th} generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

Since the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multi input multi output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio-unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there is ongoing standardization in air interface architecture/protocol regarding technologies, such as industrial Internet of things (IoT), for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### SUMMARY

An embodiment disclosed herein is to provide an apparatus and a method for effectively providing a service in a mobile communication system.

According to an embodiment, a method performed by an access and mobility management function (AMF) entity in a wireless communication system, may comprise: receiving a first message requesting information for a location of a target user equipment (UE); transmitting, to a location management function (LMF) entity, a second message for requesting the information for the location of the target UE; and receiving, from the LMF entity, a third message including the information for the location of the target UE, wherein the second message includes identification information of a serving cell for the target UE, and information indicating whether the serving cell is a moving cell.

The moving cell may include a mobile integrated access backhaul (IAB) node, and the second message may further include a mobile termination (MT) identifier of the mobile IAB node.

The second message may further include information for a UE positioning capability of the target UE, and the location of the target UE is determined based on a long term evolution positioning protocol (LPP) or a new radio positioning protocol a (NRPPa).

The second message may comprise Nlmf_Location_DetermineLocation request message, and the third message comprises Nlmf_Location_DetermineLocation response message.

The second message may further include information for a device corresponding to the serving cell for the target UE, and the information for the device corresponding to the serving cell may comprise at least one of information indicating a type of the device corresponding the serving cell, information for environment in which the device operates, a size of the device, a coverage of the serving cell, or information for a power level provided by the device.

According to an embodiment, a method performed by a location management function (LMF) entity in a wireless communication system, the method may comprise: receiving, from access and mobility management function (AMF) entity, a message for requesting information for a location of a target user equipment (UE); obtaining the information for the location of the target UE; transmitting, to the AMF entity, a message including the information for the location of the target UE; and wherein the message requesting information for the location of the target UE includes identification information of a serving cell for the target UE, and information indicating whether the serving cell is a moving cell.

The moving cell may include a mobile integrated access backhaul (IAB) node, and wherein the second message may further include a mobile termination (MT) identifier of the mobile IAB node.

The message requesting information for the location of the target UE may further include information for a UE positioning capability of the target UE, and the obtaining the information on a location of the target UE may comprise obtaining the location of the target UE using a long term evolution positioning protocol (LPP) or a new radio positioning protocol a (NRPPa).

The message requesting information for the location of the target UE may comprise Nlmf_Location_DetermineLocation request message, and the including the information for the location of the target UE message may comprise Nlmf_Location_DetermineLocation response message.

The message for requesting information for the location of a target UE may further include information for a device corresponding to the serving cell for the target UE, and the information for the device corresponding to the serving cell may comprise at least one of information indicating a type of the device corresponding the serving cell, information for environment in which the device operates, a size of the device, a coverage of the serving cell, or information fora power level provided by the device.

According to an embodiment, an access and mobility management function (AMF) entity in a wireless communication system, the AMF entity may comprise: a transceiver; and at least one processor coupled to the transceiver, wherein the at least one processor configured to: receive a first message requesting information for a location of a target user equipment (UE), transmit, to a location management function (LMF) entity, a second message requesting the information for the location of the target UE, and receive, from the LMF entity, a third message including the information for the location of the target UE, wherein the second message includes identification information of a serving cell for the target UE, and information indicating whether the serving cell is a moving cell.

The moving cell may include a mobile integrated access backhaul (IAB) node, and the second message further includes a mobile termination (MT) identifier of the mobile IAB node.

The second message may further include information for a UE positioning capability of the target UE, and the location of the target UE is determined based on a long term evolution positioning protocol (LPP) or a new radio positioning protocol a (NRPPa).

The second message may comprise Nlmf_Location_DetermineLocation request message, and the third message may comprise Nlmf_Location_DetermineLocation response message.

The second message may further include information for a device corresponding to the serving cell for the target UE, and wherein the information for the device corresponding to the serving cell may comprise at least one of information indicating a type of the device corresponding the serving cell, information for environment in which the device operates, a size of the device, a coverage of the serving cell, or information for a power level provided by the device.

According to an embodiment, a location management function (LMF) entity in a wireless communication system, the LMF entity may comprise: a transceiver; and at least one processor coupled to the transceiver, wherein the at least one processor is configured to: receive from access and mobility management function (AMF) entity, a message requesting information for a location of a target user equipment (UE), obtain the information for the location of the target UE, and transmit, to the AMF entity, a message including the information for the location of the target UE, and wherein the message requesting information for the location of the target UE includes identification information of a serving cell for the target UE, and information indicating whether the serving cell is a moving cell.

The moving cell may include a mobile integrated access backhaul (IAB) node, and wherein the second message may further include a mobile termination (MT) identifier of the mobile IAB node.

The message requesting information for the location of the target UE may further include information for a UE positioning capability of the target UE, and wherein the at least one processor may be further configured to obtain the location of the target UE using a long term evolution positioning protocol (LPP) or a new radio positioning protocol a (NRPPa).

The message requesting information for the location of the target UE may comprise Nlmf_Location_DetermineLocation request message, and wherein the message including the information for the location of the target UE may comprise Nlmf_Location_DetermineLocation response message.

The message requesting information for the location of a target UE may further include information for a device corresponding to the serving cell for the target UE, and wherein the information for the device corresponding to the serving cell may comprise at least one of information indicating a type of the device corresponding the serving cell, information for environment in which the device operates, a size of the device, a coverage of the serving cell, or information a power level provided by the device.

An embodiment disclosed herein is to provide an apparatus and a method for effectively providing a service in a mobile communication system.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates the structure of an LTE system according to an embodiment of the present disclosure;

FIG. 2 illustrates the wireless protocol structure of an LTE system according to an embodiment of the present disclosure;

FIG. 3 illustrates the structure of a next-generation mobile communication system according to an embodiment of the present disclosure;

FIG. 4 illustrates the wireless protocol structure of a next-generation mobile communication system according to an embodiment of the present disclosure;

FIG. 5 illustrates an internal structure of a UE according to an embodiment of the present disclosure;

FIG. 6 illustrates a configuration of an NR base station according to an embodiment of the present disclosure;

FIG. 7 illustrates a case in which a cell moving status is transmitted through a Nlmf_Location_DetermineLocation request message when an LMF determines to use a replaced location according to an embodiment of the present disclosure;

FIG. 8 illustrates a case in which a cell moving status is transmitted through a separate message in addition to a Nlmf_Location_DetermineLocation request message when an LMF determines to use a replaced location according to an embodiment of the present disclosure;

FIG. 9 illustrates an MO-LR where a target UE determines to use a replaced location according to an embodiment of the present disclosure; and

FIG. 10 illustrates an MT-LR where a target UE determines to use a replaced location according to an embodiment of the present disclosure.

### DETAILED DESCRIPTION

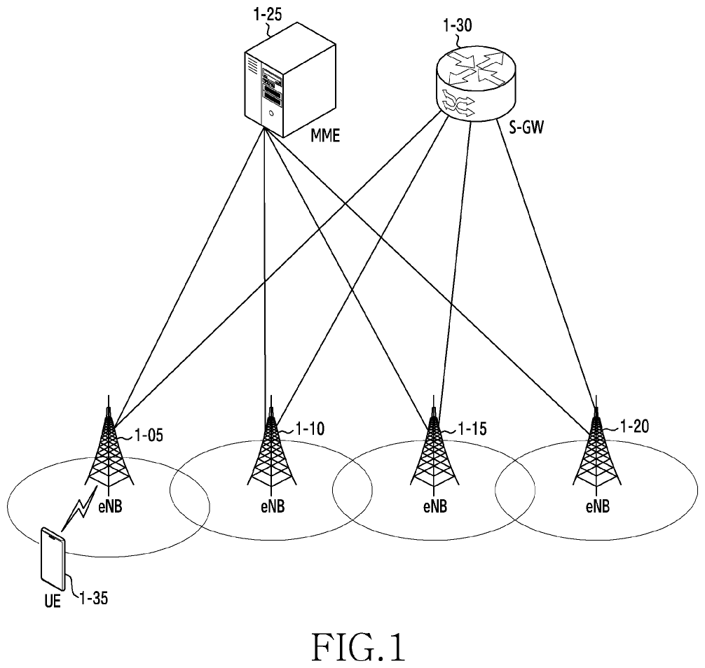

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, the operation principle of the disclosure will be described in detail with reference to the accompanying drawings. In the following description of the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. In the disclosure, a “downlink (DL)” refers to a radio link via which a base station transmits a signal to a terminal, and an “uplink (UL)” refers to a radio link via which a terminal transmits a signal to a base station. Further, in the following description, LTE or LTE-A systems may be described by way of example, but the embodiments of the disclosure may also be applied to other communication systems having similar technical backgrounds or channel types. Examples of such communication systems may include 5^{th} generation mobile communication technologies (5G, new radio, and NR) developed beyond LTE-A, and in the following description, the “5G” may be the concept that covers the exiting LTE, LTE-A, or other similar services. In addition, based on determinations by those skilled in the art, the embodiments of the disclosure may also be applied to other communication systems through some modifications without significantly departing from the scope of the disclosure. Herein, it will be understood that each block of the flowchart illustrations, and combinations of blocks in the flowchart illustrations, can be implemented by computer program instructions.

These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. As used in the embodiments of the disclosure, the term “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” or may be implemented to reproduce one or more CPUs within a device or a security multimedia card. Furthermore, the “unit” in the embodiments may include one or more processors.

In the following description, the disclosure will be described using terms and names defined in the 5GS and NR standards, which are the latest standards specified by the 3rd generation partnership project (3GPP) group among the existing communication standards, for the convenience of description. However, the disclosure is not limited by these terms and names and may be applied in the same way to systems that conform other standards. In particular, the disclosure may be applied to the 3GPP 5GS/NR (5^{th} generation mobile communication standards).

According to an embodiment of the disclosure, there is provided a signaling method and procedure required when positioning is performed by using communication between UEs, and a method for transmitting and receiving a message required for each procedure and details about transmitted and received messages are described.

According to an embodiment of the disclosure, a UE may obtain a relative or absolute location thereof through another UE.

FIG. 1 illustrates the structure of an LTE system according to an embodiment of the present disclosure.

Referring to FIG. 1, a radio access network of the LTE system may include an evolved node B (hereinafter, “eNB,” “Node B,” or “base station”) 1a-05, 1a-10, 1a-15, or 1a-20, a mobility management entity (MME) 1a-25, and a serving gateway (S-GW) 1a-30. A user equipment (hereinafter, “UE” or “terminal”) 1a-35 may access an external network through the eNBs 1a-05 to 1a-20 and the S-GW 1a-30.

In FIG. 1, the eNBs 1a-05 to 1a-20 may correspond to existing nodes B of a universal mobile telecommunication system (UMTS). The eNBs may be connected to the UE 1a -35 over a wireless channel, and may perform a more complex role than that of the existing nodes B. In the LTE system, all user traffic including a real-time service, such as a voice over Internet protocol (VoIP) service, may be served through a shared channel. Therefore, a device that collects state information, such as buffer status, available transmission power state, and channel state of UEs, and performs scheduling may be required, and the eNBs 1a-05 to 1a-20 may be responsible for these functions. One eNB may generally control a plurality of cells. For example, in order to realize a transmission speed of 100 Mbps, the LTE system may use orthogonal frequency division multiplexing (OFDM) as a radio access technology at a bandwidth of 20 MHz but is not limited to this example. In addition, the eNBs 1a-05 to 1a-20 may apply adaptive modulation & coding (AMC), which determines a modulation scheme and a channel coding rate according to the channel state of the UE. The S-GW 1a-30 may be a device that provides a data bearer and may generate or remove a data bearer under the control of the MME 1a-25. The MME may be a device that performs not only a mobility management function for the UE but also various control functions and may be connected to a plurality of base stations.

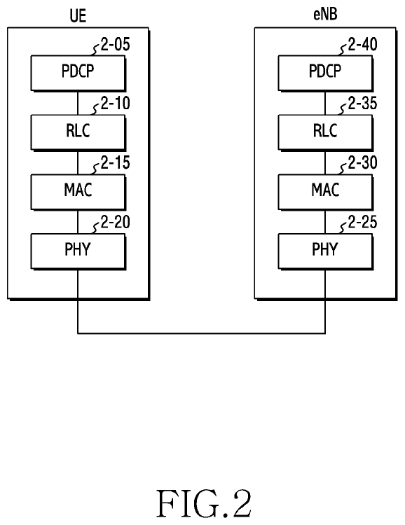

FIG. 2 illustrates the wireless protocol structure of an LTE system according to an embodiment of the present disclosure.

Referring to FIG. 2, a wireless protocol of the LTE system may include layers of packet data convergence protocols (PDCPs) 2-05 and 2-40, radio link controls (RLCs) 2-10 and 2-35, medium access controls (MACs) 2-15 and 2-30, and physicals (PHYs) 2-20 and 2-25 respectively in a UE and an eNB. The wireless protocol of the LTE system may include more or fewer layers than those illustrated in FIG. 2.

According to an embodiment of the disclosure, the PDCPs 2-05 and 2-40 may be responsible for IP header compression/decompression or the like. Main functions of the PDCPs 2-05 and 2-40 may be summarized as follows, but are not limited to the following examples:
Header compression and decompression (robust header compression (ROHC) only);
Transfer of user data;
In-sequence delivery of upper-layer PDUs at PDCP re-establishment procedure for RLC AM;
For split bearers in DC (only support for RLC AM), PDCP PDU routing for transmission and PDCP PDU reordering for reception;
Duplicate detection of lower-layer SDUs at PDCP re-establishment procedure for RLC acknowledgement mode (AM);
Retransmission of PDCP SDUs at handover and, for split bearers in DC, of PDCP PDUs at PDCP data-recovery procedure, for RLC AM;
Ciphering and deciphering; and/or
Timer-based SDU discard in uplink.

According to an embodiment of the disclosure, the radio link controls (RLCs) 2-10 and 2-35 may reconstruct a PDCP packet data unit (PDU) into a proper size and may performs an automatic repeat request (ARQ) operation. Main functions of the RLCs may be summarized as follows, but are not limited to the following examples:
Transfer of upper-layer PDUs;
Error Correction through ARQ (only for AM data transfer);
Concatenation, segmentation, and reassembly of RLC SDUs (only for UM and AM data transfer);
Re-segmentation of RLC data PDUs (only for AM data transfer);
Reordering of RLC data PDUs (only for UM and AM data transfer);
Duplicate detection (only for UM and AM data transfer);
Protocol error detection (only for AM data transfer);
RLC SDU discard (only for UM and AM data transfer); and/or
RLC re-establishment.

According to an embodiment of the disclosure, the MACs 2-15 and 2-30 may 30 may be connected to a plurality of RLC-layer devices configured in one UE, may multiplex RLC PDUs into a MAC PDU, and may demultiplex a MAC PDU into RLC PDUs. Main functions of the MACs 2-15 and 2-30 may be summarized as follows, but are not limited to the following examples:
Mapping between logical channels and transport channels;
Multiplexing/demultiplexing of MAC SDUs belonging to one or different logical channels into/from Transport Blocks (TBs) delivered to/from the physical layer on transport channels;
Scheduling information reporting;
Error correction through HARQ;
Priority handling between logical channels of one UE;
Priority handling between UEs by means of dynamic scheduling;
MBMS service identification;
Transport format selection; and/or
Padding.

According to an embodiment of the disclosure, the PHY layers 2-20 and 2-25 may perform channel coding and modulation of upper-layer data and convert the data into OFDM symbols to transmit the OFDM symbols via a wireless channel or may demodulate OFDM symbols received via a wireless channel and perform channel decoding of the OFDM symbols to deliver the OFDM symbols to an upper layer. However, the PHY layers 2-20 and 2-25 are not limited to the above functions.

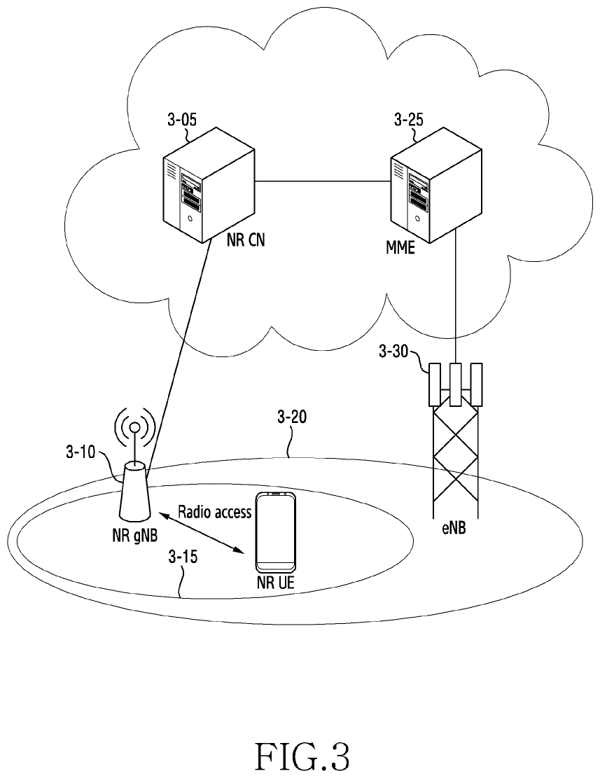

FIG. 3 illustrates the structure of a next-generation mobile communication system according to an embodiment of the present disclosure.

Referring to FIG. 3, a radio access network of the next-generation mobile communication system (hereinafter, “NR” or “5G”) may include a new radio node B (hereinafter, “NR gNB” or “NR base station”) 3-10 and a new radio core network (NR CN) 3-05. A new radio user equipment (NR UE or terminal) 3-15 may access an external network through the NR NB 3-10 and the NR CN 3-05.

In FIG. 3, the NR gNB 3-10 may correspond to an evolved node B (eNB) of an existing LTE system. The NR gNB may be connected to the NR UE 3-15 over a wireless channel, and may provide a more advanced service than that of the existing node B. In the next-generation mobile communication system, all user traffic may be served through a shared channel. Therefore, a device that collects state information, such as buffer status, available transmission power state, and channel state of UEs, and performs scheduling may be required, and the NR gNB 3-10 may 10 may be responsible for these functions. One NR gNB may control a plurality of cells.

According to an embodiment of the disclosure, the next-generation mobile communication system may employ a bandwidth greater than a current maximum bandwidth in order to realize ultrahigh-speed data transmission compared to a current LTE. Further, the next-generation mobile communication system may employ a beamforming technique in addition to orthogonal frequency division multiplexing (OFDM) as a radio access technology.

In addition, according to an embodiment of the disclosure, the NR gNB may apply adaptive modulation & coding (AMC), which determines a modulation scheme and a channel coding rate according to the channel state of the UE. The NR CN 3-05 may perform functions of mobility support, bearer setup, and quality-of-state (QoS) setup. The NR CN 3-05 may be a device that performs not only a mobility management function for the UE but also various control functions and may be connected to a plurality of base stations. The next-generation mobile communication system may also interwork with the existing LTE system, in which case the NR CN 3-05 may be connected to an MME 3-25 through a network interface. The MME 3-25 may be connected to an eNB 3-30, which is an existing base station.

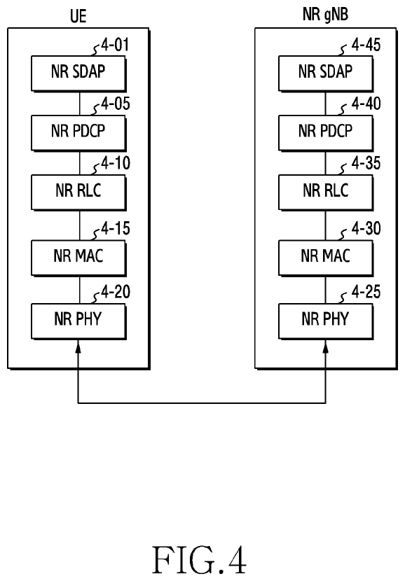

FIG. 4 illustrates the wireless protocol structure of a next-generation mobile communication system according to an embodiment of the present disclosure.

Referring to FIG. 4, a wireless protocol of the next-generation mobile communication system may include layers of NR service data adaptation protocols (SDAPs) 4-01 and 4-45, NR PDCPs 4-05 and 4-40, NR RLCs 4-10 and 4-35, NR MACs 4-15 and 4-30, and NR PHYs 4-20 and 4-25 respectively in a UE and an NR base station. The wireless protocol of the next-generation mobile communication system may include more or fewer layers than those illustrated in FIG. 4.

According to an embodiment of the disclosure, main functions of the NR SDAP layer devices 4-01 and 4-45 may include some of the following functions, but are limited to the following examples:
Transfer of user plane data;
Mapping between QoS flow and DRB for both DL and UL;
Marking QoS flow ID in both DL and UL packets; and/or
Reflective QoS flow-to-DRB mapping for UL SDAP PDUs.

Regarding the SDAP layer devices (hereinafter, “layers” interchangeable with layer devices) 4-01 and 4-45, the UE may receive a configuration about whether to use a header of the SDAP layer devices or whether to use a function of the SDAP layer devices for each PDCP layer device, each bearer, or each logical channel via a radio resource control (RRC) message. When an SDAP header is configured, the SDAP layer devices 4-01 and 4-45 may instruct the UE to update or reconfigure mapping information about a QoS flow and a data bearer in an uplink and downlink by using a one-bit non-access stratum (NAS) quality-of-service (QoS) reflective indicator (NAS reflective QoS) and a one-bit access-stratum (AS) QoS reflective indicator (AS reflective QoS) of the SDAP header. According to an embodiment, the SDAP header may include QoS flow ID information indicating QoS. According to an embodiment, the QoS information may be used as a data processing priority, scheduling information, and the like in order to support a desired service.

According to an embodiment of the disclosure, main functions of the NR PDCP-layer devices 4-05 and 4-40 may include some of the following functions, but are limited to the following examples:
Header compression and decompression (ROHC only);
Transfer of user data;
In-sequence delivery of upper-layer PDUs;
Out-of-sequence delivery of upper-layer PDUs;
PDCP PDU reordering for reception;
Duplicate detection of lower-layer SDUs;
Retransmission of PDCP SDUs;
Ciphering and deciphering; and/or
Timer-based SDU discard in uplink.

Among the above functions, the reordering function of the NR PDCP layer devices 4-05 and 4-40 may refer to a function of rearranging PDCP PDUs received in a lower layer in order on the basis of the PDCP sequence number (SN). The reordering function of the NR PDCP layer devices 4-05 and 4-40 may include a function of transmitting the data to an upper layer in the order of rearrangement, a function of immediately transmitting the data regardless of the order, a function of recording lost PDCP PDUs via reordering, a function of reporting the state of lost PDCP PDUs to a transmitter, and a function of requesting retransmission of lost PDCP PDUs.

According to an embodiment of the disclosure, main functions of the NR RLC layer devices 4-10 and 4-35 may include some of the following functions, but are limited to the following examples:
Transfer of upper-layer PDUs;
In-sequence delivery of upper-layer PDUs;
Out-of-sequence delivery of upper-layer PDUs;
Error Correction through ARQ;
Concatenation, segmentation, and reassembly of RLC SDUs;
Re-segmentation of RLC data PDUs;
Reordering of RLC data PDUs;
Duplicate detection;
Protocol error detection;
RLC SDU discard; and/or
RLC re-establishment.

Among the above functions, the in-sequence delivery function of the NR RLC layer devices 4-10 and 4-35 may refer to a function of delivering RLC SDUs received from a lower layer to an upper layer in order. The in-sequence delivery function of the NR RLC layer devices 4-10 and 4-35 may include a function of reassembling and delivering a plurality of RLC SDUs when one original RLC SDU is divided into the plurality of RLC SDUs to be received.

According to an embodiment of the disclosure, the in-sequence delivery function of the NR RLC layer devices 4-10 and 4-35 may include at least one of a function of rearranging received RLC PDUs, based on the RLC sequence number (SN) or the PDCP SN, a function of recording lost RLC PDUs via reordering, a function of reporting the state of lost RLC PDUs to a transmitter, and a function of requesting retransmission of lost RLC PDUs.

According to an embodiment of the disclosure, when there is a lost RLC SDU, the in-sequence delivery function of the NR RLC layer devices 4-10 and 4-35 may include a function of delivering only RLC SDUs before the lost RLC SDU to an upper layer in order.

According to an embodiment of the disclosure, the in-sequence delivery function of the NR RLC layer devices 4-10 and 4-35 may include a function of delivering all RLC SDUs, received before a timer starts, to an upper layer in order when the timer expires despite the presence of a lost RLC SDU.

According to an embodiment of the disclosure, the in-sequence delivery function of the NR RLC layer devices 4-10 and 4-35 may include a function of delivering all RLC SDUs received so far to an upper layer in order when the timer expires despite the presence of a lost RLC SDU.

According to an embodiment of the disclosure, the NR RLC layer devices 4-10 and 4-35 may process RLC PDUs in order of reception regardless of the order of SNs and may deliver the RLC PDUs to the NR PDCP layer devices in an out-of-sequence manner.

According to an embodiment of the disclosure, when receiving a segment, the NR RLC layer devices 4-10 and 4-35 may receive segments that are stored in a buffer or are to be received later, may reconstruct the segments into one whole RLC PDU, and may deliver the RLC PDU to the NR PDCP devices.

According to an embodiment of the disclosure, the NR RLC layer devices 4-10 and 4-35 may not include a concatenation function, and the concatenation function may be performed in the NR MAC layers or may be replaced with a multiplexing function of the NR MAC layers.

The out-of-sequence delivery function of the NR RLC layer devices 4-10 and 4-35 may refer to a function of delivering RLC SDUs received from a lower layer directly to an upper layer regardless of order. The out-of-sequence delivery function of the NR RLC layer devices 4-10 and 4-35 may include a function of reassembling and delivering a plurality of RLC SDUs when one original RLC SDU is divided into the plurality of RLC SDUs to be received. The out-of-sequence delivery function of the NR RLC layer devices 4-10 and 4-35 may include a function of recording lost RLC PDUs by storing and reordering the RLC SNs or PDCP SNs of received RLC PDUs.

According to an embodiment of the disclosure, the NR MAC layer devices 4-15 and 4-30 may be connected to a plurality of NR RLC-layer devices configured in one device, and main functions of the NR MAC layer devices 4-15 and 4-30 may include some of the following functions, but are limited to the following examples:
Mapping between logical channels and transport channels;
Multiplexing/demultiplexing of MAC SDUs;
Scheduling information reporting;
Error correction through HARQ;
Priority handling between logical channels of one UE;
Priority handling between UEs by means of dynamic scheduling;
MBMS service identification;
Transport format selection; and/or
Padding.

According to an embodiment of the disclosure, the NR PHY layer devices 4-20 and 4-25 may perform channel coding and modulation of upper-layer data and convert the data into OFDM symbols to transmit the OFDM symbols via a wireless channel or demodulate OFDM symbols received via a wireless channel and perform channel decoding of the OFDM symbols to deliver the OFDM symbols to an upper layer.

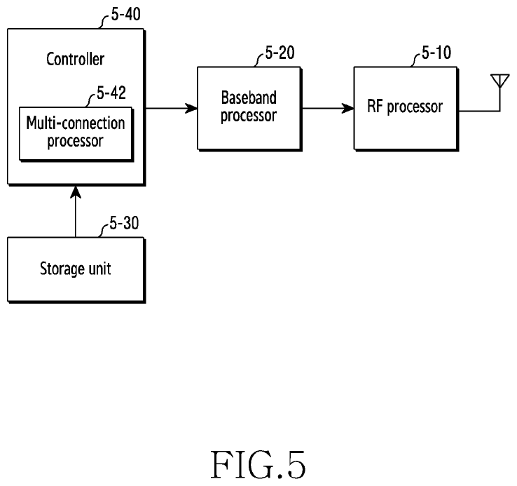

FIG. 5 illustrates a structure of a UE according to an embodiment of the present disclosure.

Referring to FIG. 5, the UE may include a radio-frequency (RF) processor 5-10, a baseband processor 5-20, a storage unit 5-30, and a controller 5-40. The UE is not limited to the foregoing example and may include fewer or more components than those illustrated in FIG. 5.

The RF processor 5-10 may perform a function for transmitting or receiving a signal through a wireless channel, such as band conversion and amplification of a signal. That is, the RF processor 5-10 may upconvert a baseband signal, provided from the baseband processor 5-20, into an RF band signal to transmit the RF band signal through an antenna, and may downconvert an RF band signal, received through the antenna, into a baseband signal. For example, the RF processor 5-10 may include a transmission filter, a reception filter, an amplifier, a mixer, an oscillator, a digital-to-analog converter (DAC), and an analog-to-digital converter (ADC) but is not limited thereto. Although FIG. 5 shows only one antenna, the UE may include a plurality of antennas. In addition, the RF processor 5-10 may include a plurality of RF chains. Further, the RF processor 5-10 may perform beamforming. For beamforming, the RF processor 5-10 may adjust the phase and strength of each of signals transmitted and received through a plurality of antennas or antenna elements. The RF processor 5-10 may perform MIMO and may receive a plurality of layers when performing multiple-input and multiple-output (MIMO). The RF processor 5-10 may 10 may perform reception beam sweeping may perform reception beam sweeping by appropriately configuring the plurality of antennas or antenna elements under the control of the controller or may adjust the orientation and width of a reception beam such that the reception beam is coordinated with a transmission beam.

According to an embodiment of the disclosure, the baseband processor 5-20 may perform a function of converting a baseband signal and a bit stream according to the physical-layer specification of a system. For example, in data transmission, the baseband processor 5-20 encodes and modulates a transmission bit stream, thereby generating complex symbols. In data reception, the baseband processor 5-20 may demodulate and decode a baseband signal, provided from the RF processor 5-10, thereby reconstructing a reception bit stream. For example, according to OFDM, in data transmission, the baseband processor 5-20 generates complex symbols by encoding and modulating a transmission bit stream, maps the complex symbols to subcarriers, and constructs OFDM symbols through an inverse fast Fourier transform (IFFT) and cyclic prefix (CP) insertion. In data reception, the baseband processor 5-20 may divide a baseband signal, provided from the RF processor 5-10, into OFDM symbols, may reconstruct signals mapped to subcarriers through a fast Fourier transform (FFT), and may reconstruct a reception bit stream through demodulation and decoding.

According to an embodiment of the disclosure, as described above, the baseband processor 5-20 and the RF processor 5-10 may transmit and receive signals. The baseband processor 5-20 and the RF processor 5-10 may be referred to as a transmitter, a receiver, a transceiver, or a communication circuit. At least one of the baseband processor 5-20 and the RF processor 5-10 may include a plurality of communication modules to support a plurality of different radio access technologies. Further, at least one of the baseband processor 5-20 and the RF processor 5-10 may include different communication modules to process signals in different frequency bands. For example, the different radio access technologies may include a wireless LAN (e.g., IEEE 802.11), a cellular network (e.g., LTE), and the like. In addition, the different frequency bands may include a super high frequency (SHF) band (e.g., 2. NRHz) and a millimeter wave band (e.g., 60 GHz). The UE may transmit or receive a signal to or from a base station by using the baseband processor 5-20 and the RF processor 5-10, and the signal may include control information and data.

According to an embodiment of the disclosure, the storage unit 5-30 stores data, such as a default program, an application, and configuration information for operating the UE. In particular, the storage unit 5-30 may store information about a second access node performing wireless communication using a second radio access technology. The storage unit 5-30 provides stored data upon request from the controller 5-40. The storage unit 5-30 may be configured as a storage medium, such as a ROM, a RAM, a hard disk, a CD-ROM, and a DVD, or a combination of storage media. The storage unit 5-30 may also be configured as a plurality of memories. According to an embodiment, the storage unit 5-30 may store a program to perform a method of allocating an IP address in an IAB system described in the disclosure.

The controller 5-40 controls overall operations of the UE. For example, the controller 5-40 transmits and receives signals through the baseband processor 5-20 and the RF processor 5-10. Further, the controller 5-40 records and reads data in the storage unit 5-30. To this end, the controller 5-40 may include at least one processor. For example, the controller 5-40 may include a communication processor (CP) to perform control for communication and an application processor (AP) to control an upper layer, such as an application. At least one component in the UE may be configured as a single chip. According to an embodiment of the disclosure, the controller 5-40 may include a multi-connection processor 5-42 to perform processing for an operation in a multi-connection mode. Each component of the UE may operate to perform embodiments of the disclosure.

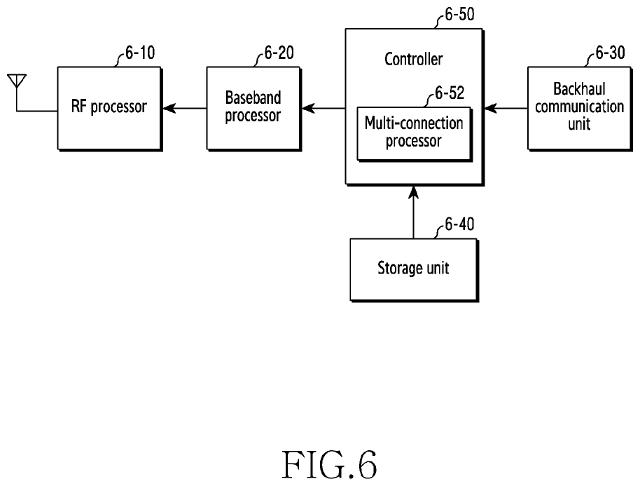

FIG. 6 illustrates a configuration of an NR base station according to an embodiment of the present disclosure.

Referring to FIG. 6, the base station may include an RF processor 6-10, a baseband processor 6-20, a backhaul communication unit 6-30, a storage unit 6-40, and a controller 6-50. The base station is not limited to the foregoing example, and may include fewer or more components than those illustrated in FIG. 6.

According to an embodiment of the disclosure, the RF processor 6-10 may 10 may perform a function for transmitting or receiving a signal through a wireless channel, such as band conversion and amplification of a signal. That is, the RF processor 6-10 upconverts a baseband signal, provided from the baseband processor 6-20, into an RF band signal to transmit the RF band signal through an antenna, and down converts an RF band signal, received through the antenna, into a baseband signal. For example, the RF processor 6-10 may include a transmission filter, a reception filter, an amplifier, a mixer, an oscillator, a DAC, and an ADC. Although FIG. 6 shows only one antenna, the RF processor 6-10 may include a plurality of antennas. In addition, the RF processor 6-10 may include a plurality of RF chains. The RF processor 6-10 may perform beamforming. For beamforming, the RF processor 6-10 may adjust the phase and strength of each of signals transmitted and received through a plurality of antennas or antenna elements. The RF processor may transmit one or more layers, thereby performing downlink MIMO.

According to an embodiment of the disclosure, the baseband processor 6-20 may perform a function of converting a baseband signal and a bit stream according to the physical-layer specification of a first radio access technology. For example, in data transmission, the baseband processor 6-20 may encode and modulate a transmission bit stream, thereby generating complex symbols. In data reception, the baseband processor 6-20 may demodulate and decode a baseband signal, provided from the RF processor 6-10, thereby reconstructing a reception bit stream. For example, according to OFDM, in data transmission, the baseband processor 6-20 generates complex symbols by encoding and modulating a transmission bit stream, maps the complex symbols to subcarriers, and constructs OFDM symbols through an IFFT and CP insertion. In data reception, the baseband processor 6-20 may divide a baseband signal, provided from the RF processor 6-10, into OFDM symbols, may reconstruct signals mapped to subcarriers through an FFT, and may reconstruct a reception bit stream through demodulation and decoding. As described above, the baseband processor 6-20 and the RF processor 6-10 may transmit and receive signals. Accordingly, the baseband processor 6-20 and the RF processor 6-10 may be referred to as a transmitter, a receiver, a transceiver, a communication unit, or a wireless communication unit. The base station may transmit or receive a signal to or from a UE by using the baseband processor 6-20 and the RF processor 6-10, and the signal may include control information and data.

According to an embodiment of the disclosure, the communication unit 6-30 provides an interface for performing communication with other nodes in a network. That is, the communication unit 6-30 may convert a bit stream, transmitted from a main base station to another node, for example, a secondary base station or a core network, into a physical signal, and may convert a physical signal, received from the other node, into a bit stream. The communication unit 6-30 may be referred to as a backhaul communication unit.

According to an embodiment of the disclosure, the storage unit 6-40 stores data, such as a default program, an application, and configuration information for operating the main base station. The storage unit 6-40 may store information on a bearer allocated to a connected UE, a measurement result reported from a connected UE, and the like. In addition, the storage unit 6-40 may store information as a criterion for determining whether to provide or stop a multi-connection to a UE. The storage unit 6-40 provides stored data upon request from the controller 6-50. The storage unit 6-40 may be configured as a storage medium, such as a ROM, a RAM, a hard disk, a CD-ROM, and a DVD, or a combination of storage media. The storage unit 6-40 may also be configured as a plurality of memories. According to an embodiment, the storage unit 6-40 may store a program to perform a method of allocating an IP address in an IAB system described in the disclosure.

According to an embodiment of the disclosure, the controller 6-50 controls overall operations of the base station. For example, the controller 6-50 transmits and receives signals through the baseband processor 6-20 and the RF processor 6-10 or through the communication unit 6-30. Further, the controller 6-50 records and reads data in the storage unit 6-40. To this end, the controller 6-50 may include at least one processor. At least one component in the base station may be configured as a single chip. Each component of the base station may operate to perform embodiments of the disclosure.

As a mobile integrated access and backhaul (IAB) node is standardized in a current wireless communication system, not only existing voice/data communication but also a positioning service is considered important for UEs receiving a communication service from a cell operated by the mobile IAB node. In most existing positioning methods, based on the actual locations of transmission/reception points (TRPs) operated by a stationary serving/neighboring base station, a UE may receive a downlink (DL) signal from the TRPs and may transmit a result of receiving the DL signal to a location management function (LMF), or the UE may transmit an uplink (UL) sounding reference signal (SRS) to a TRP and the TRP may measure the UL SRS and may transmit measured information to the LMF through a gNB, thereby measuring the location of a target UE.

Due to the mobility of the mobile IAB node, the cell operated by the node also moves, and thus positioning the UEs served by the mobile IAB node is possible only when the accuracy of the location of the moving cell is ensured.

Accordingly, the following embodiment provides a method for improving an existing TRP information request/response message for location information about a mobile cell.

In one embodiment, when an AMF receives a message associated with positioning of a target UE, such as a location service (LCS) service request of the target UE or other messages, an LMF or the target UE may identify a service of a moving cell and the state of a serving cell and may replace the location of the target UE with the location of the moving cell, thereby responding to an LCS service response of the target UE.

In one embodiment, different solutions are provide depending on an entity that determines to replace the location of the target UE with the location of the moving cell (or serving cell).

In one example, the LMF may determine to replace the location of the target UE with by the location of the serving cell.

In one example, the target terminal may determine to replace location information thereof with the location of the serving cell.

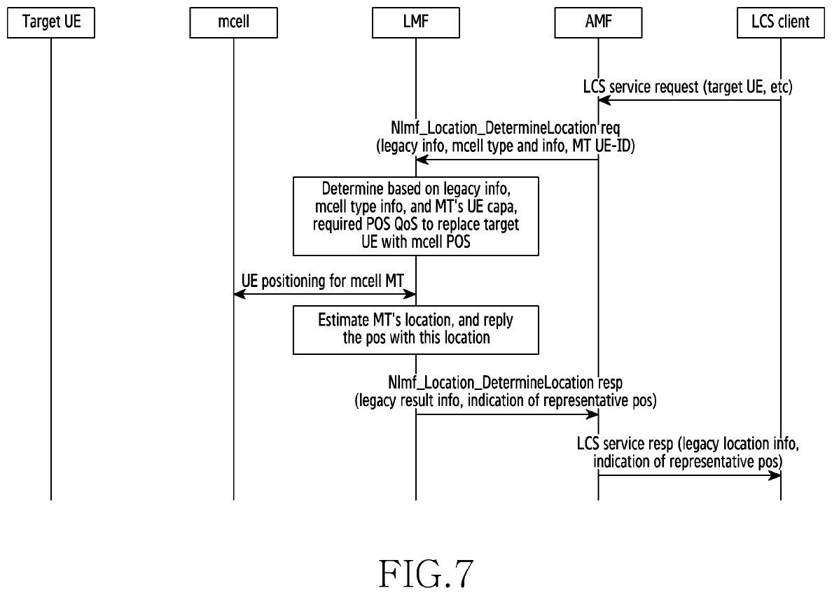

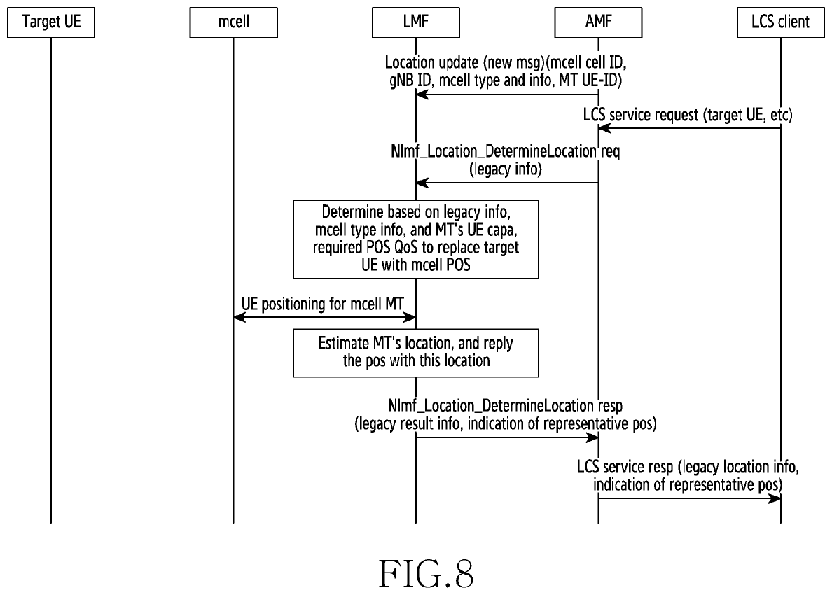

In one embodiment, a case in which the LMF determines to replace the location of the target UE with the location of the serving cell will be described in detail with reference to FIG. 7 and FIG. 8.

FIG. 7 illustrates a case in which a cell moving status is transmitted through a Nlmf_Location_DetermineLocation request message when an LMF determines to use a replaced location according to an embodiment of the present disclosure.

In one example, when an LCS service request targeted at a specific UE reaches an AMF from an external LCS client, the AMF, or a target UE, the AMF may transmit at least one of the following information when transmitting a “Nlmf_Location_DetermineLocation service operation” to the LMF. The information is not limited to the following examples. Upon receiving the Nlmf_Location_DetermineLocation service operation, the LMF may store or update at least one piece of information included in the Nlmf_Location_DetermineLocation service operation:
A target UE ID (SUPI or GPSI);
A serving cell ID (PCI and/or NR CGI) of the target UE;
A serving gNB ID of the target UE;
At least one of pieces of information received when requesting a legacy LCS service;
An indicator that a serving cell corresponds to a moving cell:
Moving cell type: Ground transportation or aerial transportation indicator and/or indicator referring to a train, a bus, urban aerial mobility (UAM), or the like and/or information indicating the physical size (or size class) or actual cell size category (large/medium/small) of the moving cell and/or DL Tx power class information and/or expected cell coverage information in addition to or separately from the indicator that the serving cell corresponds to the moving cell;
A UE-ID (SUPI or GPSI) corresponding to a mobile termination (MT) of the serving cell; and/or
UE position capability (UE POS capa) information corresponding to a UE of the MT may also be additionally transmitted.

In one example, information about the moving cell status of the serving cell and/or UE ID corresponding to the MT of the serving cell when the serving cell is the moving cell and/or POSitioningcapa information about the UE corresponding to the MT may be transmitted from the AMF to the LMF via a separate message other than the Nlmf_Location_DetermineLocation service operation, which is described in detail in FIG. 8.

In one example, upon receiving pieces of moving cell status-related information about the serving cell, the UE ID of the MT, and the POS capa information about the UE of the MT, the LMF may store and update the received information in a Nlmf_Location_determineLocation request or separate message (location update, tentatively named). Further, when identifying that the serving cell of the target UE requesting the location service through the Nlmf_location_determineLocation request message is the moving cell, the LMF may determine whether to replace location information about the target UE with location information about the MT of the moving cell. When determining to replace the location information about the target UE with the location information about the MT of the moving cell, the LMF may perform a positioning operation by selecting the UE corresponding to the MT as a target ID.

In one example, when the LMF determines replacement, the LMF may determine the replacement, based on a LCS QoS requirement and moving cell type information of the target UE and the POS UE capability information of the MT of the moving cell.

In one example, when the LMF learns the location of the MT by using an LTE positioning protocol (LPP) and NR positioning protocol a (NRPPa), the location of the MT may immediately become the replaced location of the target UE. Subsequently, the LMF may transmit a location measurement result, along with an indicator indicating that the location is a representative location, to the client/AMF/specific UE having transmitted the LCS service request.

FIG. 8 illustrates a case in which a cell moving status is transmitted through a separate message in addition to a Nlmf_Location_DetermineLocation request message when an LMF determines to use a replaced location according to an embodiment of the present disclosure.

As described above, when the LMF determines to use the replaced location, the separate message may be transmitted in addition to the Nlmf_Location_DetermineLocation request message.

For example, information about the moving cell status of a serving cell and/or a UE ID corresponding to an MT of the serving cell when the serving cell is a moving cell and/or POSitioningcapa information of a UE corresponding to the MT may be transmitted from an AMF to the LMF through a separate message other than a Nlmf_Location_DetermineLocation service operation.

Since transmission of the information from the AMF to the LMF via the separate message other than the Nlmf_Location_DetermineLocation service operation is only for updating information in the LMF, the information is stored and updated in the LMF without requesting a location service from a target UE (which may refer to FIG. 8).

The other operations correspond to FIG. 7, and thus a detailed description thereof is omitted.

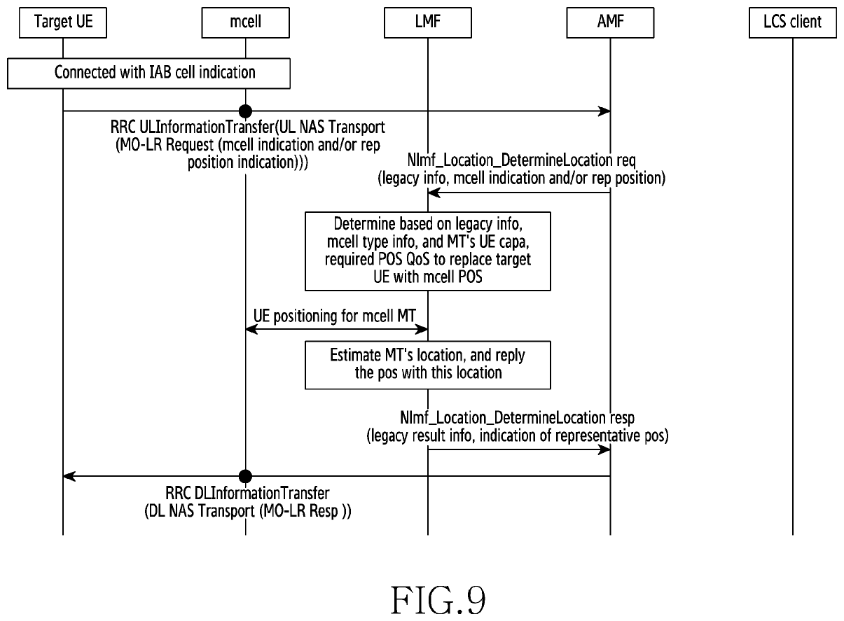

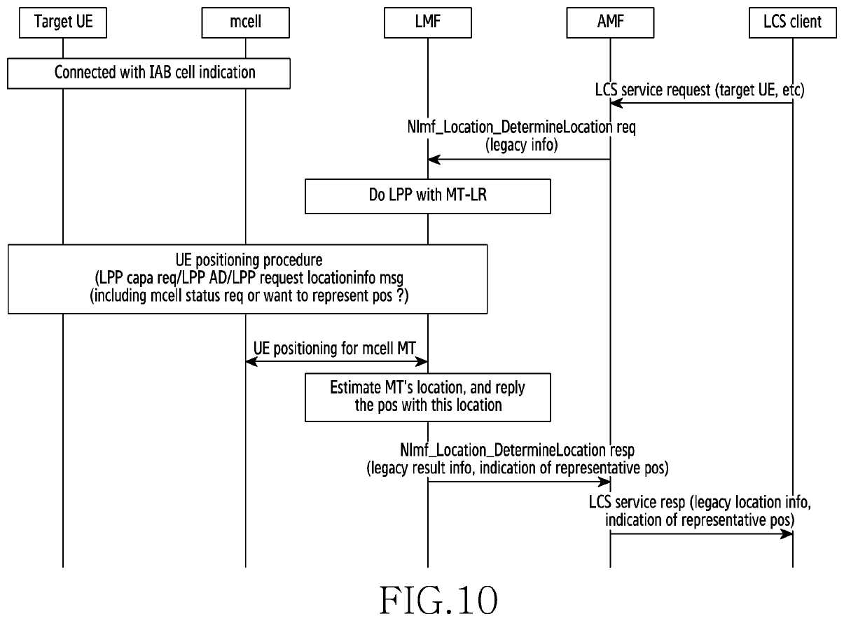

A case in which the target UE makes a determination is described in detail with reference to FIG. 9 and FIG. 10.

FIG. 9 illustrates a mobile originated location request (MO-LR) where a target UE determines to use a replaced location according to an embodiment of the present disclosure.

In a case of an MO-LR LCS, that is, when the target UE triggers an LCS service request to know the location thereof, the target UE may already recognize that the target UE exists in a specific moving cell. (An mIAB cell is broadcasting an indicator of the mIAB cell.

Accordingly, the UE may identify that a cell of the UE is the moving cell.) (which may refer to FIG. 9)

In this case, the target UE may include an indicator that the target UE is served by the moving cell and/or an indicator that the target UE wants to replace the location thereof with the location of the moving cell or the location thereof may be replaced with the location of the moving cell in an MO-LR request message in a NAS transport message.

When receiving the indicator that the target UE is served by the moving cell and/or the indicator that the target UE wants to replace the location thereof with the location of the moving cell or the location thereof may be replaced with the location of the moving cell through the NAS transport message, an AMF may transmit a Nlmf_Location_determineLocation request message including an ID of the target UE and the received indicator that the target UE wants to replace the location thereof with the location of the moving cell or the location thereof may be replaced with the location of the moving cell to an LMF. The LMF assumes that the LMF receives pieces of moving cell status-related information about a serving cell, a UE ID of an MT, and POS capa information about a UE of the MT through a separate message (location update, tentatively named) and stores (or retain) the information as in the foregoing embodiment in which the LMF determines whether to replace the location of the target UE.

When receiving the Nlmf_Location_determineLocation request, the LMF may obtain the location of the MT of the serving cell of the target UE, thereby obtaining the location of the moving cell.

An LPP location obtaining procedure and an NRPPa procedure targeted at a serving gNB of the MT may be used to obtain the location of an MT of the moving cell, that is, the location of the UE.

When the LMF estimates the location of the MT, the LMF may transmit a location result value obtained by estimating the location of the MT to the target UE via a DL NAS transport field through RRC DL Information Transfer. Here, an indicator that the result value obtained by estimating the location of the MT is a result of replacement with the location of the serving cell may be included.

FIG. 10 illustrates a mobile terminated location request (MT-LR) where a target UE determines to use a replaced location according to an embodiment of the present disclosure.

In a case of an MT-LR, that is, when a LCS service for the target UE is requested from outside, an LCS client or an AMF may request the service from an LMF.

Accordingly, the LMF may perform an LPP procedure with the target UE. Here, the target UE may transmit a response message including an indicator for asking to replace the location of the target UE with the location of the serving cell or an indicator that the location of the target UE may be replaced with the location of the serving cell to the LMF in response to an LPP message received by the target UE (which may refer to FIG. 10).

The LMF may include an indicator for requesting information about a moving cell status of a serving cell of the target UE in the LPP message. That is, the LPP message transmitted by the LMF may include an indicator for requesting information about a serving cell type of the target UE or asking whether the UE may replace the location thereof with the location of the serving cell.

The LPP message from the LMF to the target UE may be at least one of LPP capability request/LPP assistance data/LPP request Location information messages.

When a request for information about the moving cell status of the serving cell is transmitted to the target UE, the target UE may respond to the LMF with information about whether the type of the serving cell of the target UE is a mIAB cell or a UAM/UAV type UE. In addition, when an indicator for identifying (or asking) whether the target UE intends to use a replaced location is transmitted to the target UE, the target UE may include an indicator that the target UE intends to replace the location thereof with the location of the serving cell.

A message including the information about the target UE may be at least one of LPP Provide capability information/LPP Assistance data request/LPP provideLocationInformation messages.

When receiving the information about the target UE, the LMF may consider an MT of the serving cell of the target UE as a new target UE and may perform an LPP/NRPPa procedure for obtaining the location of the target UE.

When obtaining the location of the serving cell (MT of the serving cell) through the LPP/NRPPa procedure, the LMF may notify the client having requested the MT-LR of a location result value and the replaced location through the serving cell.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, local area network (LAN), Wide LAN (WLAN), and storage area network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments but should be defined by the appended claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by an access and mobility management function (AMF) entity in a wireless communication system, the method comprising:
receiving a first message requesting information for a location of a target user equipment (UE);
transmitting, to a location management function (LMF) entity, a second message requesting the information for the location of the target UE; and
receiving, from the LMF entity, a third message including the information for the location of the target UE,
wherein the second message includes identification information of a serving cell for the target UE and information indicating whether the serving cell is a moving cell.

2. The method of claim 1, wherein the moving cell includes a mobile integrated access backhaul (IAB) node, and
wherein the second message further includes a mobile termination (MT) identifier of the mobile IAB node.

3. The method of claim 1, wherein the second message further includes information for a UE positioning capability of the target UE, and
wherein the location of the target UE is determined based on a long term evolution positioning protocol (LPP) or a new radio positioning protocol a (NRPPa).

4. The method of claim 1, wherein the second message comprises Nlmf_Location_DetermineLocation request message, and
wherein the third message comprises Nlmf_Location_DetermineLocation response message.

5. The method of claim 1, wherein the second message further includes information for a device corresponding to the serving cell for the target UE, and
wherein the information for the device corresponding to the serving cell comprises at least one of information indicating a type of the device corresponding the serving cell, information for environment in which the device operates, a size of the device, a coverage of the serving cell, or information for a power level provided by the device.

6. A method performed by a location management function (LMF) entity in a wireless communication system, the method comprising:
receiving, from access and mobility management function (AMF) entity, a message requesting information for a location of a target user equipment (UE);
obtaining the information for the location of the target UE; and
transmitting, to the AMF entity, a message including the information for the location of the target UE,
wherein the message requesting information for the location of the target UE includes identification information of a serving cell for the target UE, and information indicating whether the serving cell is a moving cell.

7. The method of claim 6, wherein the moving cell includes a mobile integrated access backhaul (IAB) node, and
wherein a second message further includes a mobile termination (MT) identifier of the mobile IAB node.

8. The method of claim 6, wherein the message requesting information for the location of the target UE further includes information for a UE positioning capability of the target UE, and
wherein the obtaining the information on a location of the target UE comprises obtaining the location of the target UE using a long term evolution positioning protocol (LPP) or a new radio positioning protocol a (NRPPa).

9. The method of claim 6, wherein the message requesting information for the location of the target UE comprises Nlmf_Location_DetermineLocation request message, and
wherein the message including the information for the location of the target UE comprises Nlmf_Location_DetermineLocation response message.

10. The method of claim 6, wherein the message for requesting information for the location of a target UE further includes information for a device corresponding to the serving cell for the target UE, and
wherein the information for the device corresponding to the serving cell comprises at least one of information indicating a type of the device corresponding the serving cell, information for environment in which the device operates, a size of the device, a coverage of the serving cell, or information for a power level provided by the device.

11. An access and mobility management function (AMF) entity in a wireless communication system, the AMF entity comprising:
a transceiver; and
at least one processor coupled to the transceiver, the at least one processor configured to:
receive a first message requesting information for a location of a target user equipment (UE),
transmit, to a location management function (LMF) entity, a second message requesting the information for the location of the target UE, and
receive, from the LMF entity, a third message including the information for the location of the target UE,
wherein the second message includes identification information of a serving cell for the target UE and information indicating whether the serving cell is a moving cell.

12. The AMF entity of claim 11, wherein the moving cell includes a mobile integrated access backhaul (IAB) node, and
wherein the second message further includes a mobile termination (MT) identifier of the mobile IAB node.

13. The AMF entity of claim 11, wherein the second message further includes information for a UE positioning capability of the target UE, and
wherein the location of the target UE is determined based on a long term evolution positioning protocol (LPP) or a new radio positioning protocol a (NRPPa).

14. The AMF entity of claim 11, wherein the second message comprises Nlmf_Location_DetermineLocation request message, and
wherein the third message comprises Nlmf_Location_DetermineLocation response message.

15. The AMF entity of claim 11, wherein the second message further includes information fort a device corresponding to the serving cell for the target UE, and
wherein the information for the device corresponding to the serving cell comprises at least one of information indicating a type of the device corresponding the serving cell, information for environment in which the device operates, a size of the device, a coverage of the serving cell, or information for a power level provided by the device.

16. A location management function (LMF) entity in a wireless communication system, the LMF entity comprising:
a transceiver; and
at least one processor coupled to the transceiver, the at least one processor configured to:
receive from access and mobility management function (AMF) entity, a message requesting information for a location of a target user equipment (UE), and
obtain the information for the location of the target UE, and transmit, to the AMF entity, a message including the information for the location of the target UE,
wherein the message requesting information for the location of the target UE includes identification information of a serving cell for the target UE, and information indicating whether the serving cell is a moving cell.

17. The LMF entity of claim 16, wherein the moving cell includes a mobile integrated access backhaul (IAB) node, and
wherein a second message further includes a mobile termination (MT) identifier of the mobile IAB node.

18. The LMF entity of claim 16, wherein the message requesting information for the location of the target UE further includes information for a UE positioning capability of the target UE, and
wherein the at least one processor is further configured to obtain the location of the target UE using a long term evolution positioning protocol (LPP) or a new radio positioning protocol a (NRPPa).

19. The LMF entity of claim 16, wherein the message requesting information for the location of the target UE comprises Nlmf_Location_DetermineLocation request message, and
wherein the message including the information for the location of the target UE comprises Nlmf_Location_DetermineLocation response message.

20. The LMF entity of claim 16, wherein the message for requesting information for the location of a target UE further includes information for a device corresponding to the serving cell for the target UE, and
wherein the information for the device corresponding to the serving cell comprises at least one of information indicating a type of the device corresponding the serving cell, information for environment in which the device operates, a size of the device, a coverage of the serving cell, or information for a power level provided by the device.
